(19) United States
(12) Patent Application Publication
(10) Pub. No.: US 2019/0092966 A1
(43) Pub. Date: Mar. 28, 2019

(54) PHOTOIMAGEABLE COVERLAY COMPOSITION FOR FLEXIBLE PRINTED CIRCUIT BOARDS

(71) Applicant: Multi-Fineline Electronix, Inc., Irvine, CA (US)

(72) Inventors: YONG ZHAO, Cambridge (GB); CHRISTOPHER MILES EVANS, Essex (GB)

(21) Appl. No.: 16/138,887

(22) Filed: Sep. 21, 2018

Related U.S. Application Data
(63) Continuation of application No. 14/935,029, filed on Nov. 6, 2015, now abandoned.
(60) Provisional application No. 62/076,990, filed on Nov. 7, 2014.

(51) Int. Cl. C09D 175/06; C09D 175/08; C08G 18/42; C09D 175/16; C08F 290/06; C08G 18/48; C08G 18/34; C08G 18/67; C08G 18/08; C08G 18/66

(52) U.S. Cl. CPC C09D 175/06; C09D 175/08; C08G 18/4277; C09D 175/16; C08F 290/067; C08K 2003/3045; C08G 18/348; C08G 18/672; C08G 18/0823; C08G 18/6692; C08G 18/6659; C08G 18/4854

(57) ABSTRACT

A photosensitive coverlay composition for flexible printed circuit (FPC) boards containing specifically designed polyurethane resins with good balance of flexibility, chemical resistance and heat resistance. The photoimageable coverlay composition comprises a photosensitive polyurethane resin, a photosensitive monomer, a photoinitiator, and a thermal setting resins.

### BACKGROUND

### Field

The disclosure relates to photoimageable coverlay compositions for flexible printed circuit (FPC) boards.

### Description of the Related Technology

Conventionally, flexible printed circuits (FPC) boards are protected with polyimide film referred to as “coverlay”, in combination with solder mask, to avoid environmental and processing corrosion or damage. The coverlay requires an adhesive for lamination on FPC boards. It also requires producing openings for placing in right position. This processing is very complicated. Conventional solder masks are two parts of liquid inks and are mixed together just before application to FPC boards using screen printing. With increasing demand of miniaturization and high integration of electronic components, there is increasing demand for coverlay/solder mask with lower thickness and higher resolution. Hence, photoimageable solder masks have been developed, offering high resolution. However, solder masks are generally made of epoxy resins, which is not flexible enough to be used as coverlay for FPC boards. On the other hand, screen printable liquid solder masks are poor for via protection. It is difficult to make dry film with solder mask inks due to very short shelf-life.

It is desirable to produce a single photoimageable coverlay (PIC) that can replace the separate coverlay and solder mask on the FPC. In order for this to happen, the PIC should have good heat and chemical resistance to be able to meet the requirements of a solder mask, and should also be flexible for use as coverlay. With acceptable shelf-life, the PIC material can replace both coverlay and solder mask with single material and can be manufactured with single process. This will not only greatly simplify manufacturing process but also improve the resolution of components.

Photosensitive polyurethane acrylate is known to offer good flexibility and reasonable chemical resistance but has low heat resistance. Improvements to the low heat resistance have been described in prior art.

For example, U.S. Pat. No. 5,089,376 discloses blending a photosensitive polyurethane acrylate with a styrene/maleic anhydride copolymer to provide a photoimageable solder mask. In order to demonstrate heat resistance, the glass transition temperature of suitable styrene/maleic anhydride copolymer needs to be above 155° C. The mixing is performed at a higher temperature which has a risk of thermal polymerization. The binder affects the flexibility, which makes cured coating unsuitable for use as coverlay.

Similarly, US2006/0178448 A1 describes the use of acrylic resins containing carboxylic acid and styrene. It is known that this type of polymers have limited heat and chemical resistance.

U.S. Pat. No. 7,335,460 B2 and U.S. Pat. No. 7,670,752 B2 describe a modified epoxy resin is blended with polyurethane acrylate to produce flexible photoimageable dry film. Though the compositions offer good flexibility and long shelf-life, the blends of rigid epoxy resin with flexible polyurethane resins are not stable, and result in phase separation. That causes non-homogeneous properties of coverlay and inconsistent performance of FPC boards in particular for those with high resolution. On the other hand, without post thermal cure, of the material can have limited heat resistance.

### SUMMARY

The present disclosure provides composition containing specifically designed polyurethane resins with good balance of flexibility, chemical resistance, and heat resistance. In order to further improve heat resistance, a low quantity of epoxy resin is used to partially cure the carboxylic group of polyurethane under post thermal cure. As a result, a certain level of crosslinking is formed to enhance heat resistance and water resistance, in the meantime, a required level of flexibility still remains for use as coverlay.

Some embodiments provide a photosensitive coverlay composition comprising a photosensitive polyurethane resin, a photosensitive monomer, a photoinitiator, and a thermosetting resin.

### DETAILED DESCRIPTION

The photosensitive coverlay composition of present invention contains (A) a photosensitive polyurethane resin, (B) a photosensitive monomer, (C) a photoinitiator, and (D) a thermal setting resin. In some embodiments, the photosensitive coverlay composition further contains a filler, an additive, and/or dye/pigments.

Compound (A), a photosensitive polyurethane resin, may be synthesized by co-polymerization of diisocyanate, polyol, carboxylic polyol, and hydroxyl (meth) acrylate. The carboxylic group provides developability in alkali aqueous solution, and the (meth) acrylate offers photosensitivity.

Suitable diisocyanates include alkyl, alkenyl, alkynl, cycloakyl, and aromatic diisocyanates. Examples of suitable diisocyanates include, but are not limited to: hexamethylene diisocyanate (HMDI); 2,2,4-; or 2,4,4-trimethyl-hexamethylene diisocyanate (TMDI); tetramethylene xylene diisocyanate (TMXDI); 4,4′-diphenyl methane diisocyanate (MDI); toluene diisocyanate (TDI); and isophorone diisocyanate (IPDI). Among them, cycloalkyl and aromatic diisocyanates are preferred as they provide better heat resistance.

Polyols can be diols or triols. Diols are preferred as they produce linear structure, which are flexible and not gelled in polymer solution. Examples of polyols include, but are not limited to: ethylene glycol, propylene glycol, butanediol, hexanediol, cyclohexanedimethanol, polyethylene glycol, polypropylene glycol, poly (tetramethylene ether) glycol, and polycaprolactone diol. The preferred molecular weight of diol is in the range of about 100 to about 3000, about 500 to about 2500, or about 1000 to about 2000.

Examples of carboxylic polyols include, but are not limited to: dimethylolbutanoic acid and dimethylolpropionic acid. The acid value of resultant polyurethane is preferably about 30 mgKOH/g to about 110 mgKOH/g.

Examples of hydroxyl (meth) acrylates include, but are not limited to: 2-hydroxyethyl (meth) acrylate, 2-hydroxypropyl (meth) acrylate, 4-hydroxybutyl (meth) acrylate, and phenylglycidylether (meth) acrylate.

In some embodiments, to avoid polymerization of acrylate group, thermal polymerization inhibitors can be added. Examples of inhibitors include, but are not limited to: hydroquinone, alkyl and aryl substituted hydroquinones, and phenothiazine.

In the photosensitive coverlay composition, compound (A) is from about 20% to about 90% by weight, preferably from about 40% to about 70% by weight, based on total solid mass of composition.

The compound (B) is a mono or multi-functional (meth) acrylate monomer or oligomers which are used to enhance photosensitivity. Among them multi-functional (meth) acrylates are preferred because they offer higher photosensitivity and crosslinks which results in better chemical and heat resistance. Examples of suitable multi-functional (meth) acrylate monomers or oligomers include, but are not limited to: 1,6 hexanediol di(meth)acrylate, propoxylated neopentyl glycol di(meth)acrylate, ethoxylated bisphenol di(meth)acrylate, tricyclodecanedimethanol di(meth)acrylate, trimethylolpropane tri(meth)acrylate, trimethylolpropane ethoxylated tri(meth)acrylate, trimethylolpropane propoxylated tri(meth)acrylate, pentaerythritol tri(meth)acrylate, pentaerythritol tetraacrylate, and di-trimethylolpropane tetraacylate.

In the photosensitive coverlay composition, compound (B) is from about 0% to about 30% by weight, preferably from about 5 to about 20% by weight.

Compound (C) is a photoinitiator, or mixture of photoinitiators, that provides free radicals upon UV exposure. The free radicals initiate polymerization of (meth) acrylates. The suitable photoinitiators are but not limited to: 2,4,6-trimethylbenzoyl-diphenylphophine oxide, bis(2,4,6-trimethylbenzoyl)-phenylphosphineoxide, [1-(4-phenylsulfanylbenzoyl)heptylideneaeamino]benzoate, [1-(9-ethyl-6-(2-methylbenzoyl)carbzol-3-yl)ethylideneamino]acetate, 2-methyl-1[4-(methylthio)phenyl]-2-morpholinopropan-1-one, 2-benzyl-2-diemthylamino-1-(4-morpholinophenyl)-butanone-1,2-dimethylamino-2-(4-methyl-benzyl)-1-(4-morpholin-4-yl-phenyl)-butan-1-one, 2,2-dimethyoxy-1,2-diphenylethan-1-one, isopropylthioxanthone, 2,4-diethylthioxanthone, benzophenone, and 1-hydroxy-cyclohexyl-phenyl-ketone. The photoinitiators can be used as single or blends.

The amount of photoinitiator is from about 0.5% to about 20%, preferably from about 1% about 10% by weight.

Thermosetting resin, compound (D) is preferably an epoxy resin. Upon heating the epoxy group reacts with carboxylic acid group of polyurethane to provide a networked, cross-linked, structure that provides enhanced heat and chemical resistance. Epoxy resin contains at least two epoxy groups. The equivalent amount of epoxy group (EP) is preferably in the range of about 100 g/eq. to about 3000 g/eq., more preferably from about 150 g/eq. to about 1500 g/eq.

Examples of epoxy resins are (but are not limited to): bisphenol type resins such as bisphenol A type, bisphenol F type, bisphenol S type, nonvolak type epoxy resins, alicyclic epoxy resins, or other type epoxy resins like triglycidyl isocyanurate, etc. Among them, bisphenol type epoxy is preferable as it gives good heat and chemical resistance without compromising film flexibility.

In the present disclosure, carboxylic acid group will be fully or partially reacted with epoxy group. The molar ratio of epoxy group equivalent to carboxylic acid group is preferable in the range of about 1:1 to about 1:3.

The compositions may also contain fillers to modify physical or chemical properties such as thermal stability, flammability, appearance. In some embodiments, the fillers may provide improved heat resistance. Suitable fillers include silicon oxide, zinc oxide, alumina oxide, magnesium silicate (talc), aluminum silicate (clay), calcium carbonate and bariums sulfate. The particle size is preferably from about 0.5 um to about 10 um. The amount of fillers can be in the range of about 0% to about 50% by weight, preferably in the range of about 5% to about 30% by weight.

To further enhance flame resistance, flame retardants can be used in combination with other inorganic fillers or as fillers by themselves. Halogen-free flame retardants are preferred. Examples of such flame retardants include but are not limited to: aluminum hydroxide, magnesium hydroxide, and organo-phosphorus compounds such as melamine polyphosphate, and aluminum phosphinates, etc.

Other additives including wetting/dispersion agents, or defoamers can be used if necessary. Such wetting/dispersion agents include but are not limited to: Tego Dispers 650, Tego Dispers 685, BYK430 and FC4430. Such defoamers include but are not limited to: Tego Fomaex 805, Tego Foamex 810 and Tego Foamex N. Adhesion promoters may also be used to enhance adhesion of PIC to FPC. Such adhesion promoters include but are not limited to: benotriazole, 1-chloro-benzotriazole, 5-chloro-benzotriazole, 1-hydroxy-benzotriazole, 1-carboxy-benzotriazole, 1H-1,2,4-triazole-3-thiol and mercaptobenzimidazole. The amount of additives can be in the range of about 0% to about 10% by weight, preferably in the range of about 0% to about 5% by weight.

Additionally, different dye or pigments may be added, which includes various organic/inorganic dye pigments, carbon black, etc.

Solvents used in polymerization include but are not limited to methyl ether ketone, methyl isobutyl ketone, cyclohexanone, methylcyclohexanone, toluene, xylene, propyleneglycol monomethyl ether, dipropyleneglycol monomethyl ether, dipropyleneglycol diethyl ether, dipropyleneglycol ether acetate, petroleum naphtha, N-methylpyrrolidone, etc. Similar solvents can also be used in mixing composition.

One or more embodiments of the present disclosure will now be described in detail with reference to the following examples. However, these examples are only for illustrative purposes and are not intended to limit the scope of the one or more embodiments of the present disclosure.

### EXAMPLES

### Synthesis of Polyurethane Resin 1:

36 gm of Dimethylolpropionic acid, 67 gms of polycaprolactone diol, 0.13gm of DBTL and 100 gm of N-methylpyrolidone were mixed in a reactor at 65° C. under nitrogen flow. When the solution became clear, 97 gms of IPDI was added into the reactor. As the desired isocyanate level was reached, 24gm of HEA was added. The polymerization complete when isocyanate was completely consumed.

### Synthesis of Polyurethane Resin 2:

40 gm of Dimethylolpropionic acid, 36 gms of poly (tetramethylene ether) glycol, and 100 gm of N-methylpyrolidone were mixed in a reactor at 50° C. under nitrogen flow. When the solution became clear, 124 gms of MDI was charged into reactor. As the desired isocyanate level was reached, 33 gm of HEA was added. The polymerization completed when isocyanate was completely consumed.

TABLE 1
Representative compositions of photoimageable coverlay:

| | | Example 1 | Example 2 |
|---|---|---|---|
| | | (parts) | (parts) |
| Polyurethane | Polyurethane resin 1 | 64 | |
| resins | Polyurethane resin 2 | | 64 |
| Photosensitive | Tricyclodecanedimethanol | 8 | |
| monomers | diacrylate | | |
| | Trimethylolpropane | | 8 |
| | ethoxylated | | |
| | triacrylate | | |
| Photointiators | [1-(9-ethyl-6-(2- | 1 | 1 |
| | methylbenzoyl)carbzol-3- | | |
| | yl)ethylideneamino]acetate | | |
| | 2-methyl-1[4- | 1 | 1 |
| | (methylthio)phenyl]- | | |
| | 2-morpholinopropan-1-one | | |
| Thermal setting | Triglycidyl isocyanurate | 4 | |
| resins | Bisphenol A diglycidyl ether | | 4 |
| Fillers | Barium sulfate | 15 | 18 |
| | Silica | 4 | 1 |
| Additives | BYk430 | 2 | |
| | Foamex N | | 2 |
| Pigments | Carbon black | 1 | 1 |

The PIC composition can be directly coated onto FPC boards with screen printing. More preferably, the PIC composition is coated on plastic base to form dry film and then laminate PIC dry film on FPC boards. That will offer a better via protection and more convenient for production. A dry film can offer a better via protection because it can cover holes in FPC (such as a via), as opposed to a liquid ink, which tends to flow into holes.

After printing (with pre-dry) or lamination, PIC is exposed under UV light with desired patterns, and then developed in alkali aqueous solution (remove cover film for PIC dry film), finally thermally cured in the oven. The PIC composition in this disclosure is for use on FPC boards, but can also be used in the field of other electronic components or other applications.

The resultant PIC shows excellent performance and can pass IPC_SM-840E requirements such as good appearance, excellent plating resistance (e.g. ENIG), solvents resistance, soldering resistance with/without flux, good flexibility, good electrical insulation and good moisture resistance, etc. The present PIC dry film has long shelf life. For instance, the PIC dry film can be stored at ˜5° C. for 2 months.

What is claimed is:

1. A photosensitive coverlay composition comprising: a photosensitive polyurethane resin, a photosensitive monomer, a photoinitiator, and a thermosetting resin.

2. The photosensitive coverlay composition of claim 1, wherein the photosensitive polyurethane resin comprises: a diisocyanate, polyol, carboxylic polyol, and hydroxyl (meth) acrylate solvent.

3. The photosensitive coverlay composition of claim 2, wherein the diisocyanate is selected from the group consisting of cycloalkyl diisocyanate and aromatic diisocyanate.

4. The photosensitive coverlay composition of claim 2, wherein the polyol is a diol or a triol.

5. The photosensitive coverlay composition of claim 2, wherein the carboxylic polyol is selected from dimethylolbutanoic acid and dimethylolpropionic acid.

6. The photosensitive coverlay composition of claim 1, wherein the amount of photosensitive polyurethane resin is in the range of about 40% to about 70% by weight of total solid mass of composition.

7. The photosensitive coverlay composition of claim 1, wherein the amount of photosensitive monomer is in the range of about 5% to about 20% by weight of total solid mass of composition.

8. The photosensitive coverlay composition of claim 1, wherein the photoinitiator is in the range of about 1% to about 10% by weight of total solid mass of composition.

9. The photosensitive coverlay composition of claim 1, wherein the thermosetting resin is an epoxy resin.

10. The photosensitive coverlay composition of claim 9, wherein the composition has a molar ratio of epoxy group to carboxylic acid group in the range of about 1:1 to about 1:3.

11. The photosensitive coverlay composition of claim 1 further comprises a filler.

12. The photosensitive coverlay composition of claim 11, wherein the filler is selected from the group consisting of silicon oxide, zinc oxide, alumina oxide, magnesium silicate, aluminum silicate, calcium carbonate, bariums sulfate, aluminum hydroxide, magnesium hydroxide, melamine polyphosphate, aluminum phosphinates and a combination thereof.

13. The photosensitive coverlay composition of claim 11, wherein the filler is in the range of about 5% to about 30% by weight of total solid mass of composition.

14. The photosensitive coverlay composition of claim 1 further comprises an additive.

15. The photosensitive coverlay composition of claim 14, wherein the additive is selected from the group consisting of a defoamer, a dispersion agent, a wetting agent, a adhesion promoter, and a combination thereof.

16. The photosensitive coverlay composition of claim 14, wherein the additive is in the range of about 0.5% to about 5% by weight of total solid mass of composition.

17. The photosensitive coverlay composition of claim 1 further comprises a pigment.

18. The photosensitive coverlay composition of claim 17, wherein the pigment is carbon black and/or a color pigment.

19. The photosensitive coverlay composition of claim 17, wherein the pigment is in the range of about 0.5% to about 10% by weight of total solid mass of composition.
